(19) United States
(12) Patent Application Publication
(10) Pub. No.: US 2017/0159327 A1
(43) Pub. Date: Jun. 8, 2017

(54) HYBRID BOLT FOR A LOCK MECHANISM

(71) Applicant: Knollan Ltd., Ramat Ishai (IL)

(72) Inventors: Gilad HEFTMAN, Pardes Hana-Karkur (IL); Yehonatan KNOLL, Ramat Ishai (IL)

(21) Appl. No.: 15/321,535

(22) PCT Filed: Jun. 23, 2015
(86) PCT No.: PCT/IL2015/050640

§ 371 Date: Dec. 22, 2016

(30) Foreign Application Priority Data
Jun. 23, 2014 (IL) 233319

(51) Int. Cl. E05B 17/20; E05B 17/00; E05B 15/16; E05B 67/22

(52) U.S. Cl. CPC E05B 17/2088; E05B 67/22; E05B 17/0062; E05B 15/1635

(57) ABSTRACT

Provided is a lock including a housing, a locking mechanism, and a locking member configured for displacement with respect to the housing between a closed position and an open position, defining respective open and closed states of the lock. The lock further includes a bolt configured for displacing between an unlocked position in which the locking member is free to displace between its closed and open positions, and a locked position in which the bolt prevents displacement of the locking member between its open and closed positions. The bold bolt includes a follower and an arresting bar attached to one another and configured for displacement as a single body owing to engagement between the locking member and the follower. The follower and the arresting bar include different materials.

### TECHNOLOGICAL FIELD

The invention relates to locks, in particular, locks having a bolt made of two elements, displaceable with respect to one another.

### BACKGROUND ART

Combination locks commonly comprise a mechanism requiring the input of a certain combination code (buttons pressed at a certain order, combination of digits etc.), subject to which a latch of the lock is free to displace into an open position thereof.

One example of a combination lock is disclosed in U.S. Pat. No. 6,718,803 to the Applicant.

Acknowledgement of the above references herein is not to be inferred as meaning that these are in any way relevant to the patentability of the presently disclosed subject matter.

### GENERAL DESCRIPTION

In accordance with one aspect of the subject matter of the present application, there is provided a lock comprising a housing, a locking mechanism, a locking member configured for displacement with respect to the housing between a closed position and an open position, defining respective open and closed states of the lock, and a bolt configured for displacing between an unlocked position in which the locking member is free to displace between its closed and open positions, and a locked position in which the bolt prevents displacement of the locking member between its open and closed positions, wherein said bolt comprises a follower and an arresting bar attached to one another and configured for displacement as a single body, the follower being configured for engaging a portion of the locking member and wherein:
in an unblocked state of the locking mechanism, in which the arresting bar is free to displace, displacement of the locking member from the closed position to the open position entails displacement of the entire bolt to its unlocked position, and;
in a blocked state of the locking mechanism, in which the arresting bar is prevented from displacement, displacement of the locking member from the closed position to the open position entails disengagement of the follower from the arresting bar, leaving the arresting bar in an arrested position, preventing further displacement of the locking member into its open position.

In general, the locking mechanism is configured, upon providing the proper input (inserting the right key, setting the right combination, pressing buttons in the right order etc.) for assuming an unblocked state, allowing the bolt to freely displace into its unlocked position by virtue of displacement of the locking member

In particular, the lock can be a lock and comprise a locking mechanism similar to that disclosed, for example, in U.S. Pat. No. 6,718,803 to the Applicant.

The follower and the arresting bar can be configured for disengagement with respect to one another under a predetermined threshold load applied to either of the two members.

In particular, application of a load to the follower which is under the threshold load, will cause either of the following:
displacement of the entire bolt (if the arresting bar is free to displace)—this is equivalent to pulling on the locking member in order to open the lock when the proper input has been provided; and
resistance of the bolt (if the arresting bar is prevented from displacement)—this is equivalent to pulling on the locking member in order to open the lock when the proper input has not been provided.

However, when the arresting bar is held in place (i.e. when the proper input has not been provided), application of a load greater than the threshold load will entail disengagement of the follower from the arresting bar, bringing the lock into a malfunction state in which:
the follower is in a position corresponding to an unlocked position of the bolt; and
the arresting bar is in a position corresponding to a locked position of the bolt, preventing displacement of the locking member into its open position.

The threshold load can be determined based on the attachment arrangement between the follower and the arresting bar.

In accordance with one design embodiment, engagement between the follower and the arresting bar is in the form of a fixed attachment, whereby disengagement between the follower and the arresting bar takes place as a result of mechanical failure of a fail element, e.g. tearing or breaking off, in which case the threshold load is determined according to the physical properties (material, geometry etc.) of the fail element.

According to one example, the fail element can be constituted by a portion of one of the follower and arresting bar, received within a corresponding recess formed in the other of the components. In this case, when the threshold load (or greater) is applied, the fail element breaks off its component.

According to another example, the fail element can be a separate element, independent of the follower and arresting bar, and configured for fixedly attaching them to one another. In this case, when the threshold load (or greater) is applied, mechanical integrity of the fail element is lost, and the follower is free to displace with respect to the arresting bar.

In connection with the above, the fail element can be made of materials having a lower toughness or hardness compared to the follower. With particular reference to the first example, the arresting bar can be made of a hard metal having a first hardness and configured for preventing egress of the locking member into its open position, wherein the follower can be made of a metal having a second hardness, lower than the first hardness, and configured to fail under the threshold load. The follower can even be made of a softer material such as plastic etc.

It is important to note that the fail element should be, on the one hand, sufficiently strong in order to maintain engagement with the arresting bar during normal operation of the lock and transfer the loads applied thereto by the cam portion of the locking member to the arresting bar in order for the bolt to displace properly, and, on the other hand, to be sufficiently softer than the arresting bar so as to tear/break under the application of the threshold load or higher.

In accordance with another design embodiment, engagement between the follower and the arresting bar is in the form of a coupling, whereby disengagement between the follower and the arresting bar takes place as a result of decoupling, in which case the threshold load is determined according to the strength of the coupling.

The follower can have at least one follower surface configured for engaging a corresponding cam portion of the locking member. In particular, the arrangement can be such that axial movement of the locking member (during engagement between the cam portion and the follower surface) entails lateral movement of the follower, and, subsequently, of the entire bolt.

Thus, it is appreciated that the interaction between the locking member and the bolt is achieved via engagement between the locking member and the follower, i.e. in the unlocked state displacement of the locking bar entails displacement of the bolt via engagement with the follower.

Thus, the arresting bar of the bolt takes no operative part in engagement with the locking member and in affecting said displacement, and serves as a passive component, being driven owing to its attachment to the follower (both moving as a single body).

Therefore, the bolt is configured for performing at least the following basic functions, each configured for being performed by a different, independent component of the bolt:
displacement—performed by the bolt owing to the engagement between the locking member and the follower; and
arresting the locking member—performed by the arresting bar.

Thus, the follower can be designed according to specific requirements associated with the displacement of the bolt while the arresting bar can be designed according to specific requirements associated with the ability of the arresting bar to block the locking member. In particular, the materials of which each of the arresting bar and the follower are made can be chosen in accordance with their designated function.

This arrangement can provide the lock with several unique advantages, which cannot be achieved if the entire bold is constituted by a single body made of a single material. For example, while the arresting bar can be required to be made of a sufficiently strong/hard/tough material in order to withstand forced prying of the lock (pulling out of the locking member by force), the follower can be required to be made of a material providing low friction with the locking member in order to reduce wear and tear of the lock during repeated operation.

If the entire bolt were made of a single material, the advantages associated with the operation of displacement of the bolt could have yielded disadvantages in terms of the operation of arresting of the bolt, and vise versa, advantages associated with the operation of arresting of the bolt could have yielded disadvantages in terms of the operation of displacement of the bolt.

In accordance with a particular example, the arresting bar of the bolt can be made of a material having a hardness, for example, a range of hard metals or steels chosen according to the required security level of the lock. The hardness can be chosen to meet specific security level standards.

The follower can be made of a material having a low friction coefficient allowing smooth engagement with the locking member. More specifically, the material of the follower can be chosen from a variety of polymeric and non-polymeric materials, including (but not limited to) rubber and plastic materials. It should be noted here that since the follower is designed so as to reduce friction against the locking member, the reference to ‘material’ can also refer to a coating/s applied to the follower in order to reduce friction.

Thus, according to another aspect of the subject matter of the present application there is provided a lock comprising a housing, a locking mechanism, a locking member configured for displacement with respect to the housing between a closed position and an open position, defining respective open and closed states of the lock, and a bolt configured for displacing between an unlocked position in which the locking member is free to displace between its closed and open positions, and a locked position in which the bolt prevents displacement of the locking member between its open and closed positions, wherein said bolt comprises a follower and an arresting bar attached to one another and configured for displacement as a single body owing to engagement between the locking member and the follower, wherein the follower and the arresting bar comprise different materials.

The locking member can pass at least through the arresting bar such that, in the closed position, at least its cam portion is located axially beyond the arresting bar. Correspondingly, the arresting bar be formed with an opening having an egress portion configured for allowing axial removal of the cam portion through the arresting bar, thereby bringing the lock into its open state, and an arresting portion configured for preventing axial removal of the cam portion through the arresting bar.

The arrangement is such that in the locked position of the bolt, the arresting portion of the opening is aligned with the cam portion of the locking member, and in the unlocked position of the bolt, the egress portion of the opening is aligned with the cam portion of the locking member.

In operation, from the closed state of the lock and locked position of the bolt, axial displacement of the locking member entails engagement of the cam portion with the follower. This may yield the following:
if the locking mechanism is in an unblocked state, displacement of the bolt from its locked position to its unlocked position, bringing the egress portion of the opening to become aligned with the cam portion of the locking member, allowing the later to be removed from arresting bar and brought to the open position; and
if the locking mechanism is in a blocked state, an attempt to displace the follower to an unlocked position of the bolt. However, since the arresting bar is prevented from displacement, this yields a load on the follower, which:
   if the load is below the threshold, nothing happens, i.e. the bolt remains in place; and
   if the load is above the threshold, displacement of the follower with respect to the arresting bar.

In both cases, the arresting portion of the opening remains aligned with the cam portion of the locking member, thereby preventing its egress from the arresting bar, which, in turn, leaves the lock closed.

It is appreciated that in the second example, the lock becomes malfunctioned, as the follower disengages from the arresting bar and therefore cannot affect it anymore to displace into the unlocked position. Thus, this renders the lock jammed' and unusable.

In accordance with a specific design embodiment, the lock can be a padlock, whereby the locking member can be a shank constituting a portion of a U-shaped shackle.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic isometric view of a lock;

FIG. 2 is a schematic front view of the lock shown in FIG. 1, with a front cover thereof being removed;

FIG. 3A is a schematic isometric view of a locking assembly of the locking mechanism shown in FIGS. 1 and 2, in the closed position thereof;

FIG. 3B is a schematic front view of the locking assembly shown in FIG. 3A;

FIG. 3C is a schematic front view of the locking assembly of the locking mechanism shown in FIGS. 1 and 2, shown in mid way between its closed and open positions;

FIG. 3D is a schematic top view of the locking assembly shown in FIG. 3C;

FIG. 3E is a schematic front view of the locking assembly of the locking mechanism shown in FIGS. 1 and 2, shown in a ‘malfunction position’ thereof;

FIG. 4A is a schematic front view of a bolt of the locking assembly shown in FIG. 3A;

FIG. 4B is a schematic front view of a bolt of the locking assembly shown in FIG. 3E;

FIG. 5A is a schematic isometric view of the bolt shown in FIG. 4A;

FIG. 5B is a schematic rear isometric view of the bolt shown in FIG. 5A;

FIG. 6A is a schematic isometric view of the bolt shown in FIG. 4B;

FIG. 6B is a schematic rear isometric view of the bolt shown in FIG. 6A;

FIG. 7A is a schematic exploded view of the combination lock shown in FIG. 1;

FIG. 7B is a schematic exploded view of the combination lock shown in FIG. 7A, with the internal mechanism removed;

FIG. 8A is a schematic cross-section view of a portion of the housing of the combination lock shown in FIG. 7B; and

FIGS. 8B and 8C are schematic enlarged views of details shown in FIG. 8A.

### DETAILED DESCRIPTION OF EMBODIMENTS

It is appreciated that although the specific examples shown in and described with respect to the above mentioned figures refer to a combination lock, the subject matter of the present application can be implemented in any type of lock in which a bolt is incorporated.

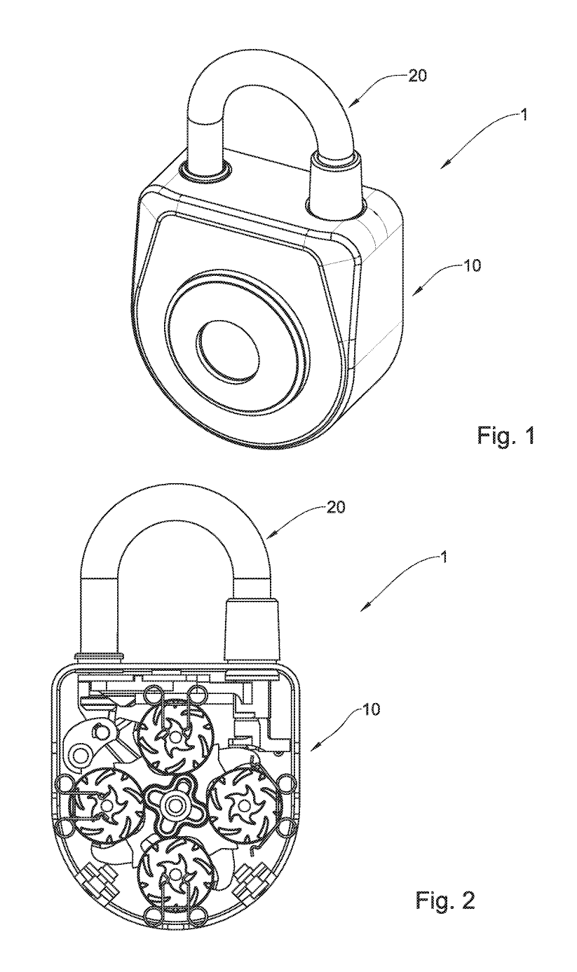

Attention is first drawn to FIGS. 1 and 2 in which a combination lock is shown, generally designated 1, and comprising a housing 10 and a shackle 20 configured for displacing between a locked position and an unlocked position, by virtue of entering the proper combination to the lock 1.

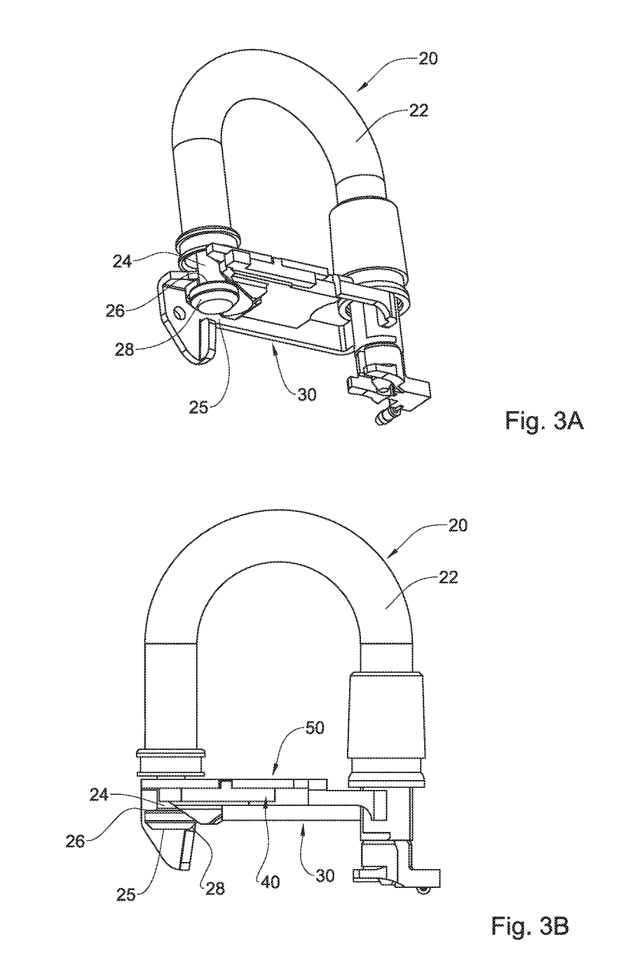

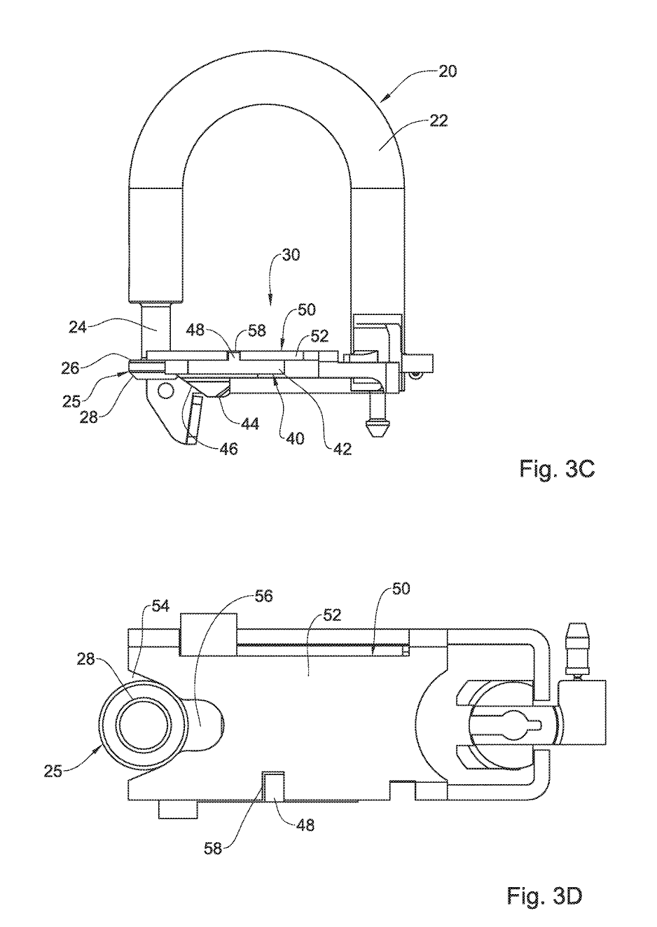

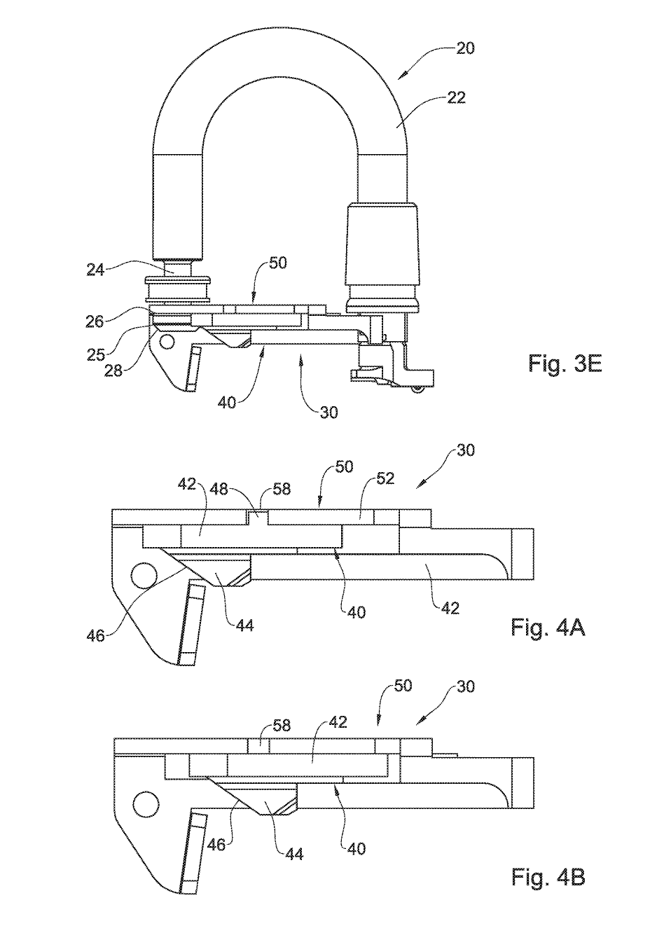

Turning now to FIGS. 3A to 3E, the shackle 20 comprises a shackle body 22, a shank 24, and a cam portion 25 formed with a first cam surface 26 and a second cam surface 28.

The lock 1 further comprises a bolt 30 received within the housing, and configured for selectively engaging the shackle 20 in order to prevent retraction thereof from the housing 10, and consequently preventing unlocking of the lock 1.

With particular reference being made to FIG. 3B, the bolt 30 comprises a follower 40, made of generally soft material (e.g. plastic) and an arresting bar 50 made of metal. The follower 40 and the arresting bar 50 are adjoined to one another via a tenon and mortise arrangement so that they are configured for displacing together as a single body.

In particular, the bolt 30 is configured for performing a lateral displacement between a first position preventing extraction of the cam portion 25 from the housing 10 and a second position allowing such extraction.

With additional reference being made to FIGS. 3C and 3D, the follower 40 has a body 42 formed with a follower portion 44 having a follower surface 46, and comprises a fail element 48 serving as the tenon. The arresting bar 50 also comprises a body 52, an opening formed with an egress portion 54 and an arresting portion 56, and a recess 58 serving as the mortise for the fail element 48.

Reverting now to FIG. 3B, the lock 1 is shown in a locked position, where the cam portion 25 of the shank 24 is received axially under the arresting portion 56 of the opening of the arresting bar 50, thereby preventing extraction of the shank 24 from the housing 10.

From this position, pulling on the shackle 24 entails axial movement of the cam portion 25 in an upwards direction. As a result, the cam surface 26 bears against the corresponding cam surface 46 of the follower 40, applying a load thereto attempting to displace the follower 40 laterally to the right.

Assuming a proper combination has been entered into the lock, the arresting bar 50 is free to displace together with the follower 40, resulting in the lateral rightward movement of the entire bolt 30 to the position shown in FIGS. 3C and 3D.

In the position shown in these figures, the bolt 30 has displaced to a sufficient amount so that the cam portion 25 of the shank 24 is located directly under the egress portion 54, allowing further extraction of the cam portion 25, thereby unlocking the lock 1.

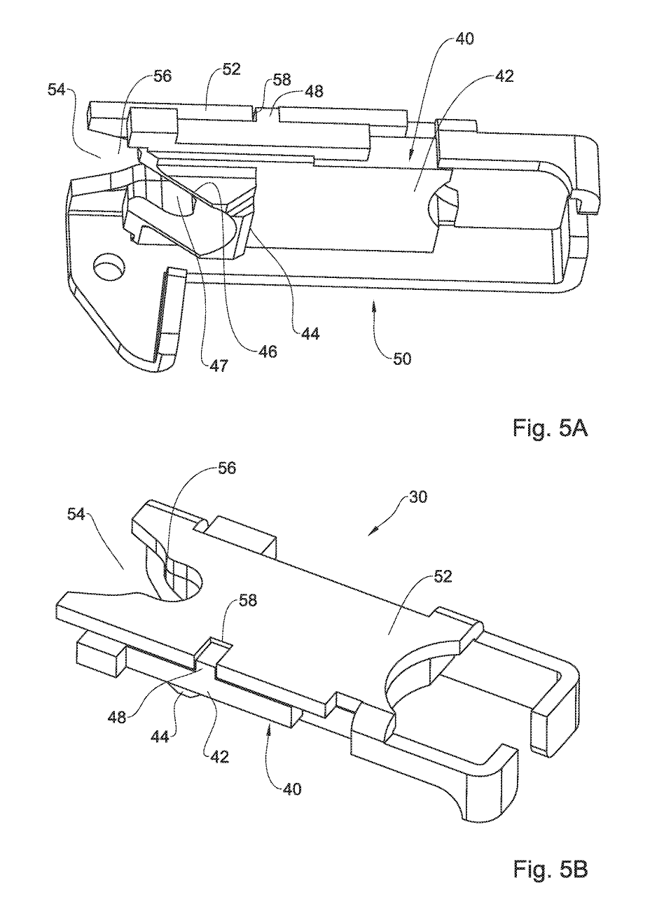

It is also noted that in this position, both follower 40 and arresting bar 50 maintain the same relation with respect to one another (i.e. have no relative displacement therebetween), as more clearly shown in FIGS. 4B, 5A and 5B.

However, from the same position shown in FIG. 3B, if the proper combination has not been entered into the lock, the arresting bar 50 will be prevented from displacement together with the follower 40. As a result, pulling on the shank 24 and applying a load to the follower 40 will result in the lateral rightward movement only of the follower 40, without the arresting bar 50, on account of tear or breaking off of the fail element 48 and disengagement of the follower 40 from the arresting bar 50.

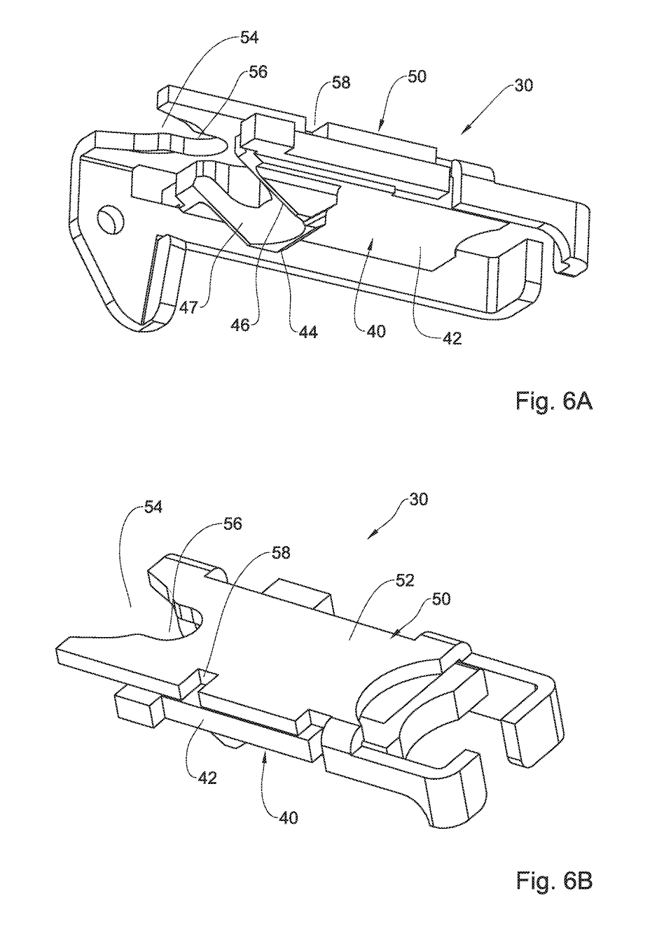

As a result, the lock 1 will assume the position shown in FIGS. 3E, 4B, 6A and 6B. In this position, the arresting bar 50 remains in the same position as it was, whereby the arresting portion 56 of the opening thereof is located above the cam portion 25 of the shank 24, preventing extraction of the shank 24 from the housing 10.

It should be noted that in order to allow opening of the lock, the arresting bar 50 should be displaced laterally. This displacement is originally induced by displacement of the follower 40 (due to its connection with the bar 50 via the fail element 48), and displacement of the follower is induced by its interaction with the cam portion 25 of the shackle 20.

This, once the follower 40 is disengaged from the arresting bar 50, the latter cannot displace into a desired position and the lock 1 becomes ‘jammed’. The housing 10 does not allow access to the arresting bar 50 (for security reasons) and therefore the lock 1 becomes ‘damaged’ or ‘malfunctioned’ with now way of reverting it back to its original position.

It is also noted that the structural integrity of the fail element 48 is designed according to the expected loads applied to the arresting bar 50 by the follower 40. In other words, the fail element 48 is configured for failing under the application of a load above a certain threshold, which defines the difference between a ‘gentle’ pull on the shackle and a violent attempt of pulling out the shackle by force.

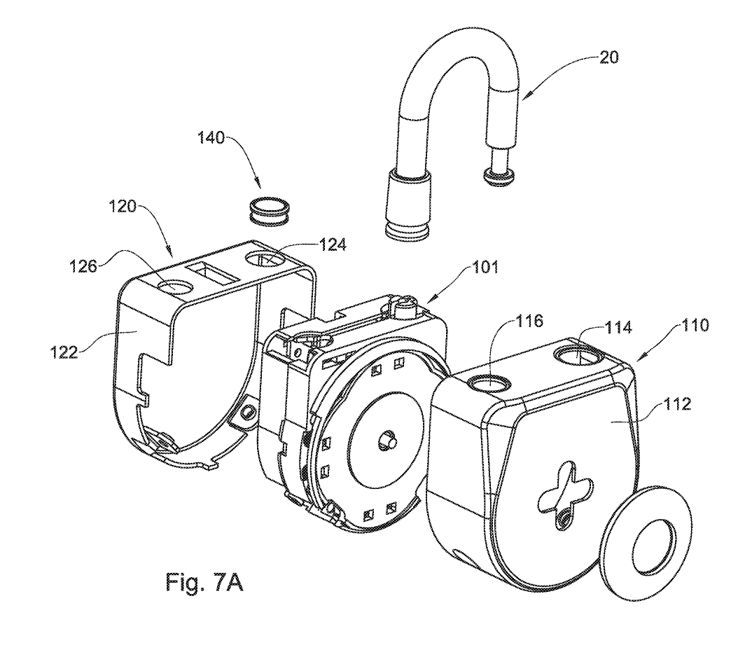

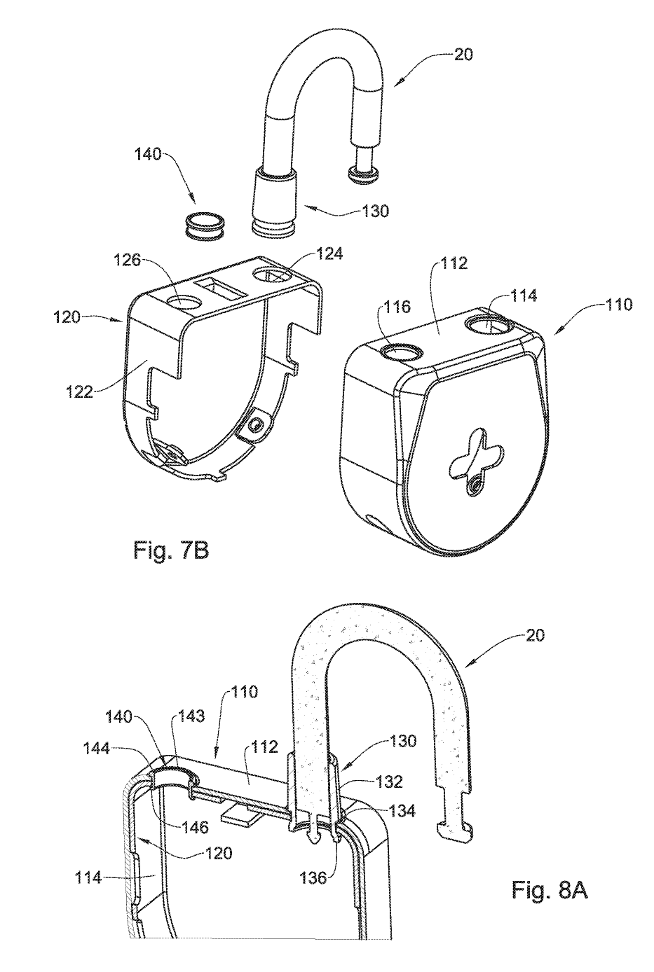

Turning now to FIGS. 7A and 7B, an exploded view of the combination lock 1 is provided, in the latter of which the combination mechanism 101 is removed for clearer representation.

It is observed that the combination mechanism 101 is retained within a housing comprising a first housing component 110 and a second housing component 120 configured for forming a full enclosure of the combination mechanism 101.

Each of the housing components 110, 120 is in the form of a shell 112, 122 respectively, each such shell 112, 122 having a first port 114, 124 configured for receiving therein a first leg of the shackle 20 and a second port 116, 126 configured for receiving therein the second leg of the shackle 20.

The first shell 112 is configured for being received within the second shell 122 so that the first ports 114, 124 are aligned with one another and the second ports 116, 126 are also aligned with one another, allowing insertion of the legs of the shackle through both ports simultaneously.

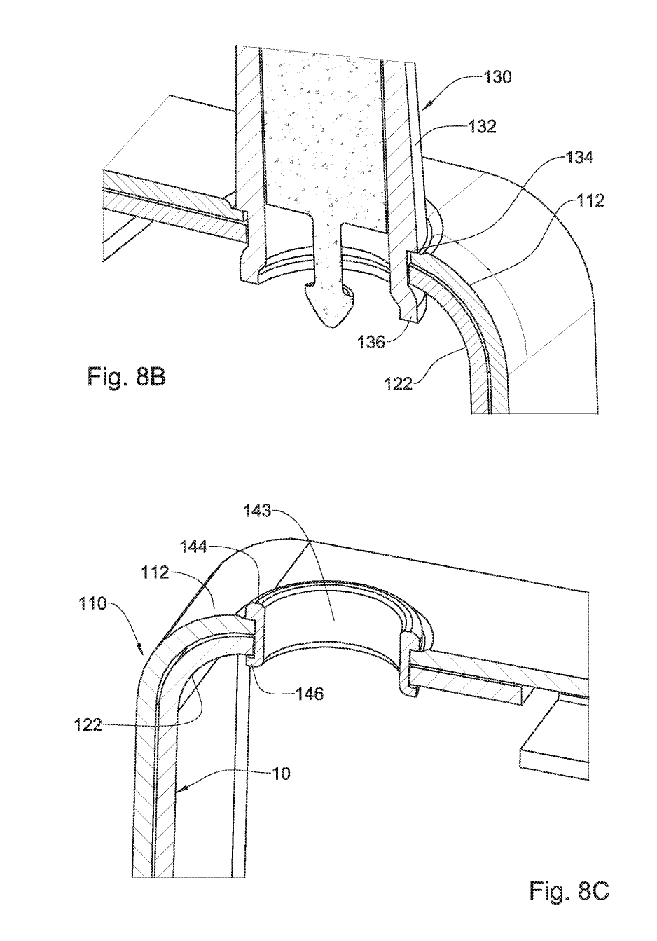

Turning now to FIGS. 8A to 8C, a cross-section of the assembled combination lock is shown in which the first sheconstitutes occupies an external part of the housing. A first sleeve 130 is inserted through the first ports 114, 124 and a second sleeve 140 is inserted through the second ports 116, 126.

In assembly, once the sleeves 130, 140 are inserted into the above ports, a purposed tool is used to form outer and inner flange portions for each of the sleeves—134, 136 for the first sleeve 130 and corresponding 144, 146 for the second sleeve 140.

The flange portions prevent axial displacement of the sleeves 130, 140 with respect to the ports, and also facilitate securing the two shells 112, 122 to one another in a manner closing off the housing and preventing access to the combination mechanism 101.

It is noted that the presence of the sleeve within the ports prevents lateral displacement of the housing components 112, 122 with respect to one another, thereby preventing disengagement of the components from one another and disassembly of the housing.

In addition, the use of sleeves allows for the use of shackles 20 of various diameters (of the cross-section of the leg of the shackle) using the same housing components 110, 120. Specifically, if a smaller diameter of the shackle is required, a thicker sleeve can be used so that the shackle leg and sleeve made up a diameter corresponding to that of the ports.

Furthermore, the arrangement of housing components 110, 120 which are separate from the combination mechanism (used only to encapsulate it), allows for simplifying manufacture and reducing costs during the quality assurance tests etc. Specifically, such tests can be performed on the combination mechanism 101 itself (without the encapsulating shell), and once performed, the combination mechanism can be encapsulated in the housing.

### Components

1—lock
10—housing
20—locking member
22—shackle body
24—shank
25—cam portion (head)
26—cam surface
28—cam surface
30—bolt
40—follower
42—follower plate
44—follower portion
46—follower surface
48—fail element
50—arresting bar
52—arresting plate
54—egress portion of the opening
56—arresting portion of the opening
58—recess (for receiving the fail element)
101—combination mechanism
110—first housing component
112—first shell
114—first port of the first housing component
116—second port of the first housing component
120—second housing component
122—second shell
124—first port of the second housing component
126—second port of the second housing component
130—first sleeve
132—sleeve body
133—inner surface of the first sleeve body
134—outer flange of the first sleeve
136—inner flange of the first sleeve
140—second sleeve
142—sleeve body of the second sleeve
143—inner surface of the second sleeve body
144—outer flange of the second sleeve
146—inner flange of the second sleeve

1-75. (canceled)

76. A lock comprising a housing, a locking mechanism, a locking member configured for displacement with respect to the housing between a closed position and an open position, defining respective closed and open states of the lock, and a bolt configured for displacing between an unlocked position in which the locking member is free to displace between its closed and open positions, and a locked position in which the bolt prevents displacement of the locking member between its open and closed positions, wherein said bolt comprises a follower and an arresting bar attached to one another and configured for displacement as a single body owing to engagement between the locking member and the follower, wherein the follower and the arresting bar comprise different materials.

77. The lock according to claim 76, wherein
in an unblocked state of the locking mechanism, in which the arresting bar is free to displace, displacement of the locking member from the closed position to the open position entails displacement of the entire bolt to its unlocked position, and
in a blocked state of the locking mechanism, in which the arresting bar is prevented from displacement, displacement of the locking member from the closed position to the open position entails disengagement of the follower from the arresting bar, leaving the arresting bar in an arrested position, preventing further displacement of the locking member into its open position.

78. The lock according to claim 76, wherein the follower and the arresting bar are configured for disengagement with respect to one another under a predetermined threshold load applied to either of the two members.

79. The lock according to claim 78, wherein application of a load to the follower which is under the threshold load, causes either of the following displacement of the entire bolt when proper input has been provided, and resistance of the bolt when proper input has not been provided.

80. The lock according to claim 78, wherein when the arresting bar is held in place, application of a load greater than the threshold load entails disengagement of the follower from the arresting bar.

81. The lock according to claim 80, wherein such disengagement brings the lock into a malfunction state in which
the follower is in a position corresponding to an unlocked position of the bolt, and
the arresting bar is in a position corresponding to a locked position of the bolt, preventing displacement of the locking member into its open position.

82. The lock according to claim 78, wherein the threshold load is determined based on the attachment arrangement between the follower and the arresting bar.

83. The lock according to claim 82, wherein engagement between the follower and the arresting bar is in the form of a fixed attachment, whereby disengagement between the follower and the arresting bar takes place as a result of mechanical failure of a fail element.

84. The lock according to claim 76, wherein the follower comprises at least one follower surface configured for engaging a corresponding cam portion of the locking member.

85. The lock according to claim 76, wherein the arresting bar is made of a harder material than that of the follower.

86. A lock comprising a housing, a locking mechanism, a locking member configured for displacement with respect to the housing between a closed position and an open position, defining respective closed and open states of the lock, and a bolt configured for displacing between an unlocked position in which the locking member is free to displace between its closed and open positions, and a locked position in which the bolt prevents displacement of the locking member between its open and closed positions, wherein said bolt comprises a follower and an arresting bar attached to one another and configured for displacement as a single body, the follower being configured for engaging a portion of the locking member, wherein
in an unblocked state of the locking mechanism, in which the arresting bar is free to displace, displacement of the locking member from the closed position to the open position entails displacement of the entire bolt to its unlocked position, and
in a blocked state of the locking mechanism, in which the arresting bar is prevented from displacement, displacement of the locking member from the closed position to the open position entails disengagement of the follower from the arresting bar, leaving the arresting bar in an arrested position, preventing further displacement of the locking member into its open position.

87. The lock according to claim 86, wherein the follower and the arresting bar are configured for disengagement with respect to one another under a predetermined threshold load applied to either of the two members.

88. The lock according to claim 87, wherein application of a load to the follower which is under the threshold load, causes either of the following displacement of the entire bolt when proper input has been provided, and resistance of the bolt when proper input has not been provided.

89. The lock according to claim 87, wherein when the arresting bar is held in place, application of a load greater than the threshold load entails disengagement of the follower from the arresting bar.

90. The lock according to claim 89, wherein such disengagement brings the lock into a malfunction state in which
the follower is in a position corresponding to an unlocked position of the bolt, and
the arresting bar is in a position corresponding to a locked position of the bolt, preventing displacement of the locking member into its open position.

91. The lock according to claim 87, wherein the threshold load is determined based on the attachment arrangement between the follower and the arresting bar.

92. The lock according to claim 91, wherein engagement between the follower and the arresting bar is in the form of a fixed attachment, whereby disengagement between the follower and the arresting bar takes place as a result of mechanical failure of a fail element.

93. The lock according to claim 91, wherein the fail element is made of materials having a lower toughness or hardness as compared to the follower.

94. The lock according to claim 86, wherein the arresting bar and the follower are made of different materials.

95. A bolt for a lock according to claim 86.
